(19) United States
(12) Patent Application Publication
(10) Pub. No.: US 2009/0050446 A1
(43) Pub. Date: Feb. 26, 2009

(54) METHOD FOR TRANSPORTING A PARTICULATE MATERIAL AND A TRANSPORTATION DEVICE FOR A PARTICULATE MATERIAL

(76) Inventors: Mike Cliff, Cheshire (GB); Rainer Klumpp, Speyer (DE); Klaus Schuhmacher, Reheinhausen (DE)

Correspondence Address: MORGAN LEWIS & BOCKIUS LLP, 1111 PENNSYLVANIA AVENUE NW, WASHINGTON, DC, 20004, US

(21) Appl. No.: 11/995,662

(22) PCT Filed: Jul. 13, 2006
(86) PCT No.: PCT/SE2006/000877

§ 371 Date: Sep. 11, 2008

(30) Foreign Application Priority Data
Jul. 15, 2005 (SE) 0501687-8

(51) Int. Cl. B65G 47/74; B65G 11/00; B65G 47/20

(52) U.S. Cl. 198/546; 198/617

(57) ABSTRACT

In a first aspect the invention relates to a method for transporting a particulate material from a container, down a chute (2) to a subsequent process step, in order to overcome a vertical distance. Furthermore, the method comprises the steps of, providing a head (11) in the chute (2), which head is movable in the axial direction of the chute, moving the head (11) to the upper part of the chute (2), charging said particulate material onto the top of the head (2), lowering the head (11) to the lower part of the chute (2), and opening a passage (26) through the head (11) to the subsequent process step in order to let the particulate material there through. The invention also relates to a transportation device for carrying out said method.

### TECHNICAL FIELD

The present invention relates generally to the field of transporting particulate materials from a first position to a second, lower position in a controlled way, e.g. charging a particulate material from a container to a tablet press machine in the tablet manufacturing industry. Thus, the present invention relates to a method for transporting a particulate material from a container, down a chute to a subsequent process step, in order to overcome a vertical distance.

The invention also relates to a transportation device for carrying out said method.

### BACKGROUND

In industries where powders are pressed into tablets or encapsulated, more precisely in the pharmaceutical industry, the manufacturing process is dependent on an efficient charging of the mixed powder to the subsequent tablet forming or capsule-filling machine. However, it shall be pointed out that the present invention can be applied to other industries than the pharmaceutical and/or to transportation of not only powder, but also granulates, tablets, pills, etc.

Usually a pharmaceutical plant is divided into a technical area and a processing area. Process areas may be situated on different levels or floors with the technical area in the ceiling void above the lower processing area. In the upper process area the different substances and appropriate active agents are handled and mixed with each other to form a uniform powder. From this process step, the powder shall be transported through the floor to a subsequent process step, e.g. a tablet press machine in the process area below. The mixed powder is stored and transported in an intermediate bulk container used in the upper process area. Said container is placed above and connected to a connector, or powder charge point, the outlet of the intermediate container is closed by an outlet valve. From the connector a chute, or pipe, leads through the floor and to the tablet press machine, in order to overcome the vertical distance between the container and the machine. The powder shall not leak out of the transfer chute into the technical area between the two levels. A lower valve is provided between the chute and the machine in order to control the flow to the machine.

When said intermediate bulk container outlet valve is opened the powder falls down into the chute, the lower end of which is closed by means of the lower valve. This free fall adversely affects the uniformity of the powder. The uniformity of the powder shall be good and precise, since the medical tablets might be harmful or without effect if the mixture is incorrect.

During the free fall of the powder, the air column, which is present in the chute at the time the container valve is opened, may be forced downwards past the lower valve, if the lower valve is open, into the tablet press machine filling it with dust. If the lower valve is closed the air is forced upwards, through the flow of powder or, as the powder falls down. Fine/light particles of the mixture will follow the fluidizing air upwards, i.e. be stripped from the powder mixture, and the larger/heavier particles will fall faster towards the lower valve of the chute. This mechanism is called elutriation and causes a segregation of the powder. Due to the segregation it is not abnormal that the active agent content of the tablets varies downwards if the fine/light particles are the active agent or upwards if the fine/light particles are non-active. It is not abnormal for the extent of this variation in active agent content to take the tablets outside their accepted limit for active agent content, which will cause part or the whole batch being manufactured to be rejected.

One solution to solve this problem with elutriation segregation is to reduce the falling speed of the powder in the chute. Conventional attempts to solve the problem use principally four different methods.

A first method uses a twisted flexible polythene, or similar material, tube or liner as a chute. As the powder reaches the top of the chute, the entire length of the tube is twisted and the powder is stopped on top of the twisted liner. When the tube is untwisted from the top downwards at a pre-determined speed, the speed of the flow of the powder is decreased, in relation to free fall.

A second method uses a tube or liner, which is compressed between two rollers, which are placed on opposite sides of the liner. Said rollers start at the top of the chute and are lowered along the tube at an appropriate speed, the falling speed of the powder being decreased. At the lower end of the tube/liner the rollers part allowing the powder to fall to the process machine below.

A third method uses a flexible liner inside a solid chute. At intervals along this chute a series of pinch/bladder valves collapse the liner from the outside. As the powder reaches the top of the chute it can only fall as far as the first constriction. The first pinch valve is then released allowing the powder to fall to the second constriction. This procedure is repeated until the powder has reached the bottom of the chute. The more constriction applied to the liner in this device the better from the powder flow point of view, but on releasing each constrictions the powder is in free fall until the next constriction risking elutriation.

However, these three methods use flexible liners which are very easily damaged by the handling thereof or by sharp elements in the surroundings. Additionally, the liners can not be cleaned in situ, and since each different product needs a clean production equipment the liner has to be exchanged very often.

A fourth method uses a solid plug, which is movable inside a pipe and connected to a piston rod extending into the pipe from below. The plug can be moved up and down in order to reduce the speed of the powder flow. A great drawback of this method is that the pipe usually is one or several meters long. Since the piston rod must have a length of stroke as long as the pipe an equally large area underneath the pipe is required. Furthermore, the machine to which the powder is directed can not be placed directly underneath the pipe. Instead the powder must fall free down a second pipe to reach the machine.

It is highly desirable to provide a chute needing less maintenance, i.e. a chute having long durability. The above mentioned chutes need maintenance and manual cleaning between each product, which is unnecessarily cumbersome and costly.

At present, there are no transportation devices having deceleration arrangements working entirely satisfactory without drawbacks.

### SUMMARY OF THE INVENTION

The present invention aims at obviating the aforementioned disadvantages of previously known methods for decelerating the powder speed in a charging operation, and at providing an improved method. A primary object of the present invention is to provide an improved method of the initially defined type with respect to the ability of reducing/preventing segregation of the powder during transportation. It is another object of the present invention to provide a transportation device that is self cleaning. It is yet another object of the present invention to provide a transportation device having an improved durability. It is another object of the invention to provide a transportation device without consumption parts, such as a liner or the like.

According to the invention at least the primary object is attained by means of the initially defined method and transportation device having the features defined in the independent claims. Preferred embodiments of the present invention are further defined in the dependent claims.

According to a first aspect of the present invention, there is provided a method of the initially defined type, which is characterized by the steps of;
providing a head in the chute, which head is movable in the axial direction of the chute;
charging said particulate material onto the top of the head;
lowering the head after charging said particulate material, and
opening a passage allowing the particualte material to pass the head to the subsequent process step (4).

According to a second aspect of the present invention, there is provided a transportation device according to claim 6.

Thus, the present invention is based on the insight of utilizing a movable element inside the chute for controlling the powder during the transportation thereof down the chute, which element does not obstruct the flow of powder during subsequent operation.

In a preferred embodiment of the present invention, the head is moved by means of air pressure/vacuum. This means that the length of the chute does not effect the equipment associated with the head.

### BRIEF DESCRIPTION OF THE DRAWINGS

A more complete understanding of the above mentioned and other features and advantages of the present invention will be apparent from the following detailed description of preferred embodiments in conjunction with the appended drawings, wherein:

FIG. 1 is a schematic side elevational view of a transportation device according to the present invention,

FIG. 2 is a cross sectional view of the chute and the head, the head being in the lower most position,

FIG. 3 is an enlarged cross sectional view of the head, the pinch valve being open,

FIG. 4 is an enlarged cross sectional view of the head, the pinch valve being closed, and

FIG. 5 is a perspective view of the head.

### DETAILED DESCRIPTION OF PREFERRED EMBODIMENTS OF THE INVENTION

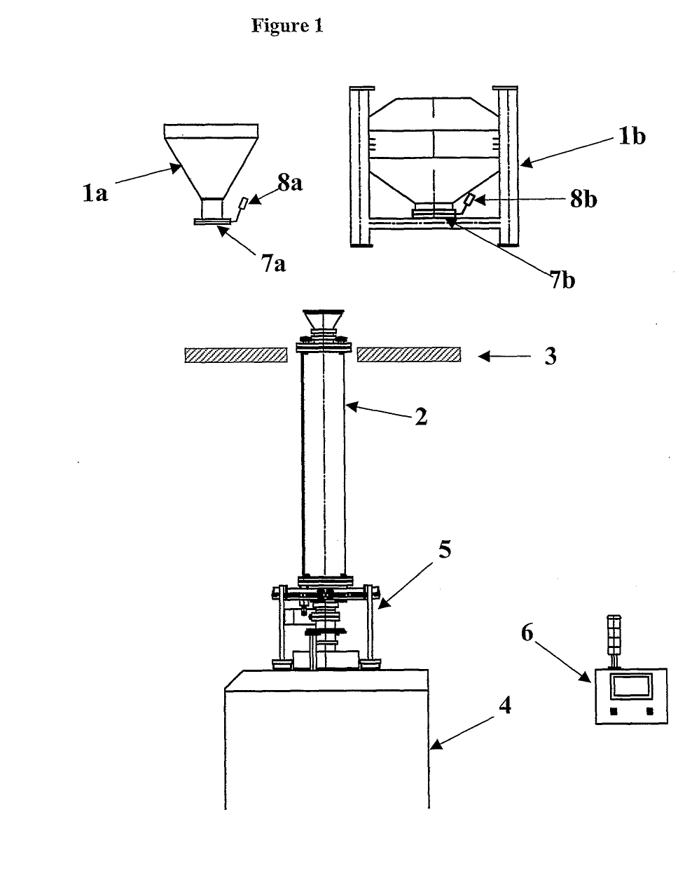

With reference to FIG. 1, there is shown a schematic view of a multi floor arrangement of a feeding/transportation device for a particulate material. It shall be pointed out that the term “particulate materials”, is used for sake of simplicity in the description as well as in the claims and includes powder, granulates, tablets, pills, etc. The powder is stored in a fixed hopper or similar, such as a mixer, 1a or a movable container 1b placed above and connected to an upper end of a chute or pipe 2. The chute 2 leads down through a floor, schematically shown by reference number 3, and is connected to a subsequent process step, schematically shown at reference number 4. A tablet press or encapsulator, another container, or the like may constitute the subsequent process step 4. The chute 2 in FIG. 1 is supported on frame 5 off the tablet press machine or similar reference 4. The chute 2 may also be supported from the underside of the level above. A control panel 6 is provided, arranged to control different functions of the transportation device. The control panel 6 may be attached to process equipment 4 or to an adjacent wall.

The outlet valve 7a/b of either the fixed hopper or similar 1a or the movable container 1b controls the flow of powder into the chute 2. The outlet valve 7a/b, controlled by a lever 8a/b in the shown embodiment, but may be controlled in other ways, pneumatically, electrically, etc. The outlet valve 7a/b prevents the powder from falling down into the chute 2 before the powder-charging step.

The cross section of the chute 2 is preferably circular, but may present any other suitable shape, oval, polygonal, etc., as long as the cross section of the chute 2 is uniform through out the entire axial direction.

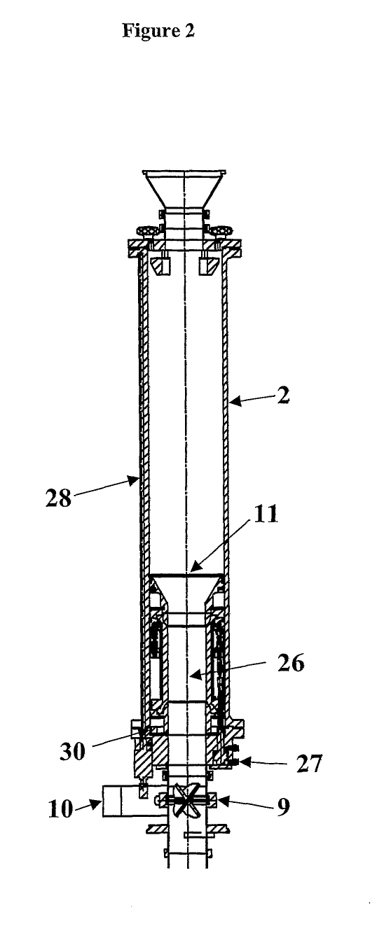

Reference is now also made to FIG. 2. In the lower end of the chute 2 is provided a lower valve 9, controlled pneumatically by an actuator 10 in the shown embodiment, but the lower valve 9 may be controlled in other ways, manually, electrically, etc. The function of the lower valve 9 is to control the flow of powder from the chute 2 to the subsequent process step 4. The container outlet valve 7b and lower valve 9 fully close the inlet and outlet of the chute 2. The length of the chute 2 may vary greatly, depending on the application, and a normal length is about 1.5-3 m. The diameter of the chute 2 is approximately 0.2 m in the shown embodiment, but the diameter is dependent on the product transported and the application as such. At the lower end of the chute 2 is provided a head 11 inside the chute 2.

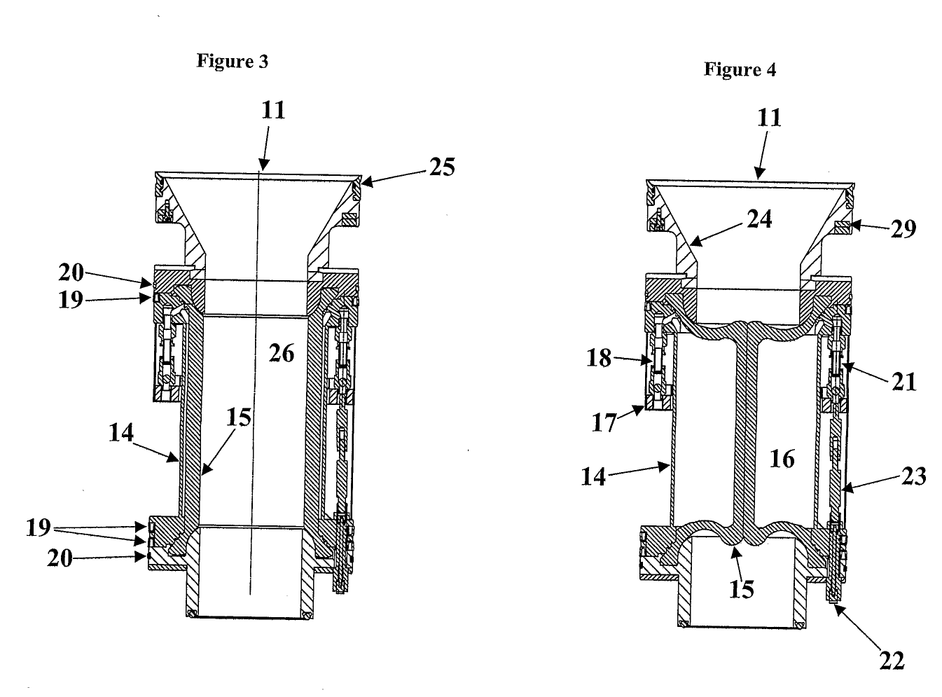

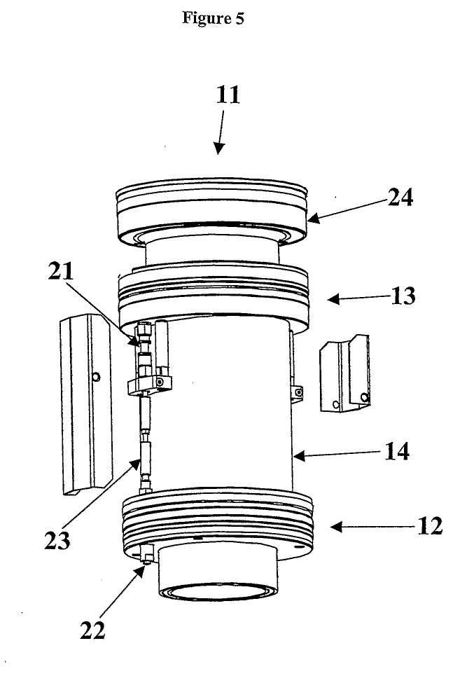

Reference is now also made to FIGS. 3, 4 and 5. There is shown a decelerator head or plug 11, in cross section in FIGS. 3 and 4 and in perspective in FIG. 5. The head 11 presents a generally tubular outer shape. Further, the head 11 presents a lower flange 12 and an upper flange 13, distanced in the axial direction by a main body 14. Inside the main body 14 of the head 11 and between said lower and upper flanges 12, 13 extend a tubular bellow 15. The bellow 15 is clamped to the head 11 at said lower and upper flanges 12, 13. A clearance 16 determined by the outside of the bellow 15 and the inside of the main body 14 may be filled with pressurized air by means of an inflation device 17. The inflation device 17 comprises a none return valve 18 provided between the clearance 16 and the area outside the main body 14. When the area between the main body 14 and the inside of the chute 2 is pressurized with air, the air will enter the inflation device 17 and past the none return valve 18 to the clearance 16. When the clearance 16 is inflated, the bellow or pinch valve 15 is compressed and closes the free passage 26 through the head 11 (see FIG. 4). Air seals 19 and guide rings 20 are provided all around the lower and upper flanges 12, 13. The function of the guide rings 20 is to lower the friction between the head 11 and the inside of the chute 2, and the function of the air seals 19 is to prevent air from leaking past the flanges 12, 13.

In order to deflate the clearance 16, the head 11 is provided with a pressure relief means 21. The pressure relief means 21 comprises an activating pin 22, which activates the relief means 21 via push rod 23. When the activating pin 22 is activated or forced upwards, a free air passage from the clearance 16 to below the head 11 is opened and the bellow 15 will return to its original shape (see FIG. 3).

The main body 14, and with that the bellow 15, has an oval cross sectional shape (see FIG. 5), in order to help the bellow 15 to be compressed in a smooth and controlled way. Above the upper flange 13 is provided a transition cone 24 comprising a scraper seal 25 running along the inside of the chute 2 during operation and preventing the particulate material from leaking past the outside of the head 11. The transition cone 24 reduces the powder flow cross section from that of the chute 2 to that of the bellow 15.

The following example describes the device during operation. A container 1b accommodating a particulate material is placed above and connected to the upper end of the chute 2. The container valve 7b and lower valve 9 are closed. The head 11 is located at the lower end of the chute 2 and the bellow 15 is open as in FIGS. 2 and 3. An air pressure of approximately 4 bar is applied to the clearance 16, which closes the bellow 15 as in FIG. 4. A weaker bellow 15 needs a lower air pressure to close the channel 26. Preferably, the clearance 16 shall be inflated, as shown in FIG. 4, to ensure a proper closure of the through channel 26 of the head 11. As an alternative to the passage 26 (not shown), the particulate material may be allowed to pass between the outer periferi of the head and the inside of the chute. Further, the passage 26, or the alternative passage, may be closed and opened by any suitable means.

Next, an air pressure of approximately 0.5 bar is applied underneath the head 11, in order to move the head upwards inside the chute 2. A greater or lower air pressure underneath the head 11, result in a different speed of movement of the head 11. The air pressure is supplied through an air supply connection 27 present at the lower end of the chute 2 and connected to a compressed air pump or the like. The air displaced from the chute as the head rises is vented underneath the container valve 7b. Once the head 11 reaches the upper end of the chute 2, the container valve 7b may be opened. Upon opening of the container valve 7b the powder in the container 1b is charged on the top of the head 11, i.e. filling the transition cone 24 of the head 11 down to the pinch valve or bellow 15. During the charging of the powder, the head 11 is held in place by the air pressure underneath. Next, the air pressure underneath the head 11 is vented through an air outlet in the lower end of the chute 2. As the air pressure decreases the head 11 moves downwards. It is optional to apply a vacuum or partial vacuum underneath the head 11 to increase the lowering speed of the head 11. The powder follows the head 11 downwards in a slow and controlled way, in an adapted and predetermined speed. The position of the head 11 in the chute 2 is determined by a liner position sensor 28 which detects a ring magnet 29 built into the transition cone 24 of the head 11. Once the head 11 reaches the lower end of the chute 2, the activating pin 22 is operated by means of an activator ring or the like 30. The activator ring 30 is raised and engages the activating pin 22 by pressing it upwards, which deflates the clearance 16 and the channel 26 is opened. The open channel 26 lets the particulate material reach down to the lower valve 9. The lower valve 9 has been closed during the entire operation, in order to manage to operate the overpressure/underpressure underneath the head 11. When the machine 4, or subsequent process step, is ready to receive the powder, the lower valve 9 is opened.

After the batch of powder is used up, the container and lower valves 7b, 9 are closed. The pinch valve 15 is closed and the head 11 is moved to the upper end of the chute 2, as described above. During this movement the scraper 25 scrapes out the inner side of the chute 2. The small amount of dust accumulated on top of the head 11 is easily removed when the head 11 is in the upper end of the chute 2. Another or a supplementary way of cleaning the chute 2 is to place the head 11 at the lower end of the chute 2 and close the pinch valve 15. Water and/or detergent is charged above the head 11, and then the head 11 is used to clean the chute 2 by repeatedly moving the head 11 up and down. After completed cleaning the pinch valve 15 is opened and the water is discharged through the head 11 and the open lower valve 9. The chute 2 and the head 11 need to be thoroughly dried after such a cleaning, before the next batch of powder, e.g. by letting a flow of warm air through the chute 2 and head 11.

It is also desired to be able to remove the head 11 from the chute 2, during maintenance or replacement of the head 11. For example, this can be done by removing an upper collar of the chute 2 and using air pressure as described above to drive the head 11 to the absolute top of the chute 2, where the head 11 can be manually removed. Another way is to remove a lower collar of the chute 2 and thereby enable manual removal of the head 11 from the lower end of the chute 2. Yet another way of accomplish the removal of the head 11 from the chute 2 is to use a chute 2, which is divided just above the head 11 when it is in its lower most position. By swinging out this lower portion of the chute 2 the head 11 is accessible to be manually removed.

The invention is not limited only to the embodiments described above and shown in the drawings. Thus, the method as well as the transportation device may be modified in all kinds of ways within the scope of the appended claims.

It shall be pointed out that all references to “upper”, “lower”, etc., shall be interpreted in conjunction with the drawings, and the drawings shall be oriented in such a way that the reference numbers can be read in a normal way.

It shall also be pointed out that even though the term “particulate materials”, for sake of simplicity, has been used in the claims as well as in the description, it shall be realized that powder, dust, granulates, tablets, pills, etc., are included.

1. A method for transporting a particulate material from a first, upper position, down a chute (2) to a subsequent process step (4) located at a second, lower position, in order to overcome a vertical distance, comprising the steps of;
providing a head (11) in the chute (2), which head is movable in the axial direction of the chute;
charging said particulate material onto the top of the head (2);
lowering the head (11) after charging said particulate material, and
opening a passage allowing the particulate material to pass the head (11) to the subsequent process step (4).

2. The method according to claim 1, wherein said particulate material is passing through a passage (26) in the head (11).

3. The method according to claim 1, wherein an air pressure is applied underneath the head (11) to move the head to the upper part of the chute (2).

4. The method according to claim 1, wherein at least a partial vacuum is applied underneath the head (11) to move the head to the lower part of the chute (2).

5. The method according to claim 1, wherein the head (11) is hollow and provided with a valve (15), the valve being closed during the movement to the upper part of the chute (2), during the charging of the particulate material and during the movement to the lower part of the chute (2).

6. The method according to claim 5, wherein said valve (15) is pneumatically operated.

7. A transportation device for a particulate material, comprising a chute (2) adapted to transport particulate material from a first upper position to a subsequent process step (4) located at a second, lower position, characterized in that a head (11) is provided inside the chute (2), the head being reciprocating movable between a first, upper position in which the particulate material is charged onto the top of the head (11) and a second, lower position in which the particulate material is admitted to flow passed the head (11) to the subsequent process step (4).

8. The transportation device according to claim 7, wherin the particulate material is admitted to flow through a passage (26) in the head (11).

9. The transportation device according to claim 7, wherein the head (11) is provided with air seals (19) at the outer surface thereof, in order to be movable between the first, upper position and the second, lower position by means of air pressure.

10. The transportation device according to claim 7, wherein the head (11) is hollow and provided with a valve (15) arranged to open and close the passage (26) provided to allow the particulate material to pass the head (11).

11. The transportation device according to claim 9, wherein the valve (15) is pneumatically operated.

12. The transportation device according claim 7, further comprising a transition cone (24) comprising a scraper seal (25), said scraper seal being adapted to run along the inside of the chute 2 during operation whereby the particulate material is prevented from leaking past the outside of the head (11).
